(19) United States
(12) Patent Application Publication
(10) Pub. No.: US 2012/0081850 A1
(43) Pub. Date: Apr. 5, 2012

(54) Rack Assembly for Housing and Providing Power to Information Handling Systems

(75) Inventors: Laurent A. Regimbal, Round Rock, TX (US); Brandon J. Brocklesby, Pflugerville, TX (US)

(73) Assignee: DELL PRODUCTS L.P., Round Rock, TX (US)

(21) Appl. No.: 12/895,519

(22) Filed: Sep. 30, 2010

(51) Int. Cl. G06F 1/16

(52) U.S. Cl. 361/679.02

(57) ABSTRACT

A rack assembly is disclosed including a frame and a housing for receiving a plurality of information handling system (IHS) components, the housing coupled to a slide assembly attachable to the frame, wherein the frame is operable to receive the housing. The assembly further includes an extendable member electrically coupling the housing to a power source disposed within the frame when the housing is in an extended position from the frame.

### TECHNICAL HELD

The present disclosure relates generally to the field of information handling systems (IHSs), and more specifically, to chassis for housing IHS components.

### BACKGROUND

As the value and use of information continues to increase, individuals and businesses seek additional ways to process and store information. One option available to users is an information handling system (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for such systems to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

One type of IHS is a server system typically including a midplane to allow multiple blades to be interconnected in a single chassis and share a common power source. A server system containing multiple blades is hereinafter referred to as a “multi-blade server system”.

During the operation of a multi-blade server system, a user may need to modify, by adding, removing or replacing, IHS components of a blade. Modification of an IHS component may be necessary if a blade becomes corrupt or if the user desires to add more components to the blade for performance purposes. To modify IHS components of a blade, a user may typically shut down the entire server system, and then uninstall the blade to add new IHS components or replace damaged IHS components of the blade. This method may require time to shut down the server system. In doing so, a user may lose the functionality of certain blades while the server system is shut down.

Alternatively, a user may modify IHS components of a blade and “hot plug” the blade into the server system. Hot plugging a blade may allow a user to modify IHS components of the blade while operating other blades of the server system. Hot plugging provides the advantage that a user does not have to shut down the entire server system and lose functionality of the other blades. However, to modify IHS components of a blade in this implementation, a user may need to extract an entire blade from the server system and lose functionality of the blade.

A user may want to replace damaged IHS components or add new IHS components to a blade without losing the functionality of the blade. While the blade remains inside the chassis of the server system, the front face of the blade typically allows access to IHS components to be modified. Due to the blade structure, the front face of each blade may have limited surface area. Thus, access to the components of the blade may be constrained by the limited area of the front face of each blade. In a server system generally known in the art, particularly ones which hold at least two hard drive disks in the front of each blade, the modification of IHS components disposed in the rear portion of each blade may be prevented without further alterations to the structure of the blade.

Thus, a need exists for an improved blade structure for facilitating the modification of IHS components and maximizing the accessibility of the IHS components residing within the blade.

### SUMMARY

The following presents a general summary of several aspects of the disclosure in order to provide a basic understanding of at least some aspects of the disclosure. This summary is not an extensive overview of the disclosure. It is not intended to identify key or critical elements of the disclosure or to delineate the scope of the claims. The following summary merely presents some concepts of the disclosure in a general form as a prelude to the more detailed description that follows.

One aspect of the disclosure provides for a rack assembly including a frame and a housing for receiving a plurality of information handling system (IHS) components, the housing coupled to a slide assembly attachable to the frame, wherein the frame is operable to receive the housing. The assembly further includes an extendable member electrically coupling the housing to a power source disposed within the frame when the housing is in an extended position from the frame.

Another aspect of the present disclosure provides for an information handling system (IHS) including a chassis and a blade server having a first slide assembly mounted within the chassis, wherein the first slide assembly is operable to receive the blade server. The system may also include a frame disposed within the blade server and a housing for receiving a plurality of information handling system (IHS) components, the housing having a second slide assembly attachable to the frame, wherein the frame is operable to receive the housing. The system may further include an extendable member electrically coupling the housing to a power source disposed within the frame when the housing is in an extended position from the frame.

Yet another aspect of the disclosure provides an information handling system (IHS) including a chassis and a plurality of blade servers disposed within the chassis. Each of the plurality of blade servers may include a first slide assembly mounted within the chassis for receiving each of the plurality of blade servers, a frame counted within each of the plurality of the blade servers, and a housing for receiving a plurality of information handling system (IHS) components, the housing having a second slide assembly attachable to the frame, wherein the frame is operable to receive the housing. Further, each of the plurality of blade servers may include an extendable member electrically coupling the housing to a power source disposed within the frame when the housing is in an extended position from the frame.

### BRIEF DESCRIPTION OF THE DRAWINGS

For detailed understanding of the present disclosure, references should be made to the following detailed description of the several aspects, taken in conjunction with the accompanying drawings, in which like elements have been given like numerals and wherein:

FIG. 1 represents an information handling system (IHS) in accordance with one aspect of the present disclosure;

FIG. 2 represents a server system in accordance with one aspect of the present disclosure; and

FIG. 3 provides a fully extended position of a blade within the server system of FIG. 2.

### DETAILED DESCRIPTION

Before the present apparatus and systems are described, it is to be understood that this disclosure is not limited to the particular apparatus or systems described, as such may vary. One of ordinary skill in the art should understand that the terminology used herein is for the purpose of describing possible aspects and/or implementations only, and is not intended to limit the scope of the present disclosure which will be limited only by the appended claims.

The present disclosure is not limited in its application to the details of construction and the arrangement of components set forth in the following description or illustrated in the drawings. The present disclosure is capable of other implementations or aspects and of being practiced or of being carried out in various ways. Also, the use of “including,” “comprising,” “having,” “containing,” “involving,” “consisting” and variations thereof, is meant to encompass the items listed thereafter and equivalents thereof as well as additional items.

It must also be noted that as used herein and in the appended claims, the singular forms “as” “and,” and “the” may include plural referents unless the context clearly dictates otherwise. Thus, for example, reference to “a blade” refers to one or several blades and reference to “a method for facilitating” includes reference to equivalent steps and methods known to those skilled in the art, and so forth.

Also, terms of orientation such as “top,” “bottom,” “upper,” “lower,” “front,” “frontward,” “rear,” “rearward,” and “end” are used herein to simplify the description of the context of the illustrated implementations. Likewise, terms of sequence, such as “first” and “second,” are used to simplify the description of the illustrated implementations. However, other orientations and sequences are possible, and the present disclosure should not be limited to the illustrated orientation(s). Those skilled in the art will appreciate that other orientations of the various components are possible.

For purposes of this disclosure, an implementation of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example., an IHS may be a personal computer, a storage device, server (i.e., server system), blade server, or any other suitable device and may vary in size, shape, performance, functionality, and price. The IHS may include random access memory (RAM), one or more processing sources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

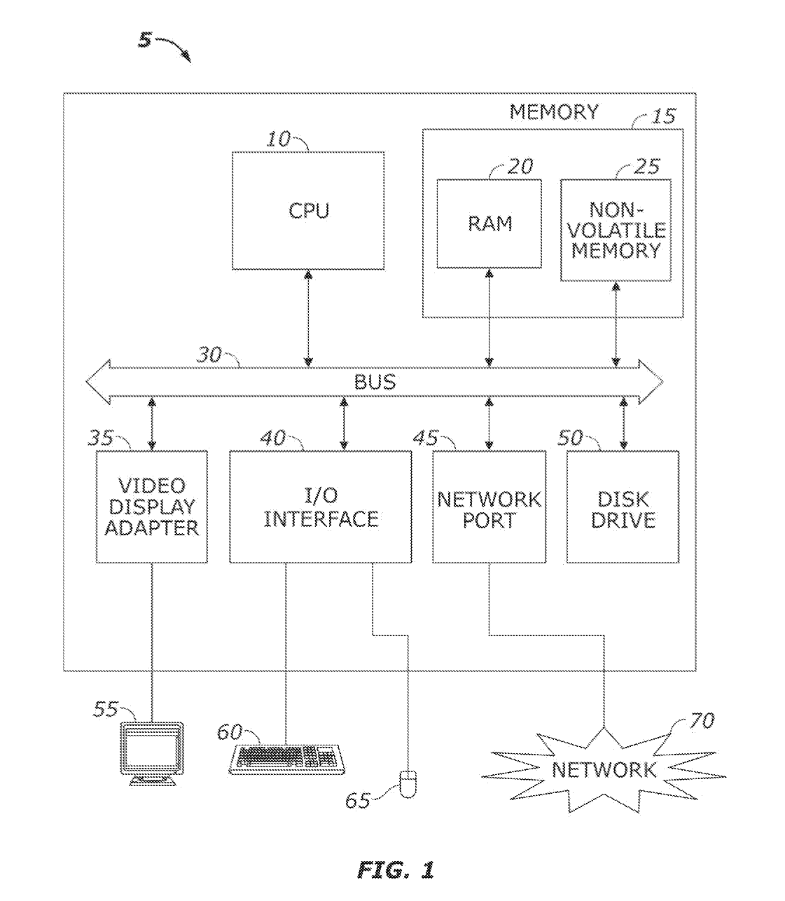

FIG. 1 illustrates one possible implementation of an IHS 5 comprising a CPU 10. It should be understood that the present disclosure has applicability to IHSs as broadly described above, and is not intended to be limited to the IHS 5 as specifically described. The CPU 10 may comprise a processor, a microprocessor, minicomputer, or any other suitable device, including combinations and/or a plurality thereof, for executing programmed instructions. The CPU 10 may be in data communication over a local interface bus 30 with components including memory 15 and input/output interfaces 40. The memory 15, as illustrated, may include non-volatile memory 25. The non-volatile memory 25 may include, but is not limited to, firmware flash memory, non-volatile random access memory (NVRAM), and electrically erasable programmable read-only memory (EEPROM). The non-volatile memory 25 may contain a firmware program (not shown) which may contain programming and/or executable instructions required to control a keyboard 60, mouse 65, video display 55 and/or other input/output devices not shown here. This type of firmware may be known as a basic/input output system (BIOS). The memory may also comprise random access memory (RAM) 20. The operating system and application programs (e.g., graphical user interfaces) may be loaded into the RAM 20 for execution.

The IHS 5 may be implemented with a network port 45 to permit communication over a network 70 such as a local area network (LAN) or a wide area network (WAN), such as the Internet. As understood by those skilled in the art, IHS 5 implementations may also include an assortment of ports and interfaces for different peripherals and components, such as video display adapters 35, disk drives port 50, and input/output interfaces 40 (e.g., keyboard 60, mouse 65).

IHS components, as used herein, may refer to any components mentioned in the present disclosure including, but not limited to, memory, processors, storage media, or input/output (I/O) interfaces.

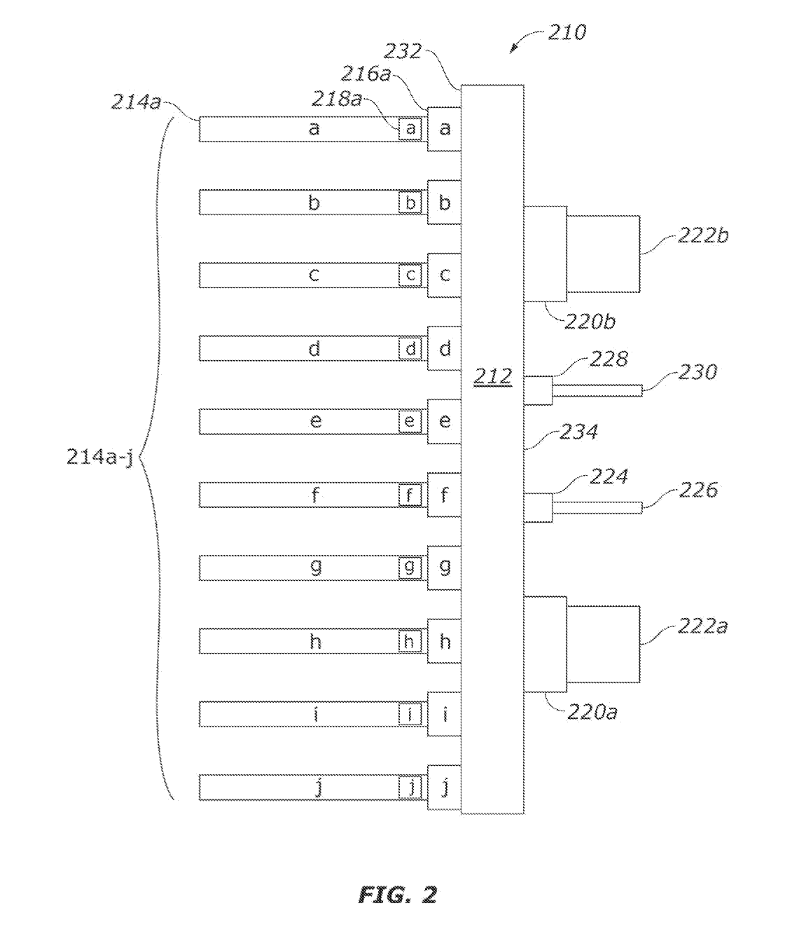

FIG. 2 illustrates a server system, indicated generally at 210, as one possible type of IHS. The server system 210, such as a multi-blade server system, may include blade servers 214a-j coupled via a midplane 212 (i.e., midplane interposer). In some implementations, each of the blade servers 214a-j may be equipped with hot plug functions. Examples of possible hot plug devices include., but are not limited to, hard drives, peripheral component interconnect (PCI) cards, and dual in-line memory modules (DIMMS). Hot plug functionality may allow each of the blade servers to be disconnected from the server system 210 without affecting functionalities of other blade servers 214a-j remaining in the server system 210.

In the present implementation, the midplane 212 is a circuit board coupled to server elements including, but not limited to, blade connectors 216a-j, power source connectors 220a-b, power supplies 222a-b, a management card connector 224, a management card 226, a Network Interface Card (NIC) connector 228, and a NIC 230. It should be understand that in other implementations, the midplane 212 may be coupled to some of the aforementioned sever elements or to additional elements not mentioned previously.

The midplane 212 is illustrated as having ten blade connectors 216a-j and ten blade servers 214a-j on one side 232 of the midplane 212. The power connectors 220a-b, the power supplies 222a-b, the NIC connector 228, the NIC 230, the management card connector 224 and the management card 226 may be coupled to the server system on any side 234 of the midplane 212. Accepting the blade servers 214a-j or the power supplies 222a-b on the side 232 or the side 234 of the midplane 212 allows for multi-blade server system 210 to have a flexible modular design to meet a user's preference.

The midplane 212 may allow the blade servers 214a-j to be communicatively coupled and to share the power sources 222a-b or other sources such as the NIC 230 and the management card 226. The midplane 212 may receive multiple blade servers 214a-j. In alternate implementations, the midplane 212 may hold more or less than the ten server blades 214a-j as depicted. System administrators may easily increase or decrease the processor density of the midplane 212 by adding or removing the blade servers 214a-j coupled to the midplane 212.

The blade connectors 216a-j are also associated with the midplane 212. The blade connectors 216a-j provide an interface between the blade servers 214a-j and the midplane 212 whereby each blade connector 216a-j coupled to the midplane 212 receives one blade server 214a-j. The midplane 212 does not require all blade connectors 216a-j to have a blade server 214a-j installed for proper functionality of the entire server system 210. In general, at least one blade server 214a-j installed in at least one blade connector 216 is sufficient for proper functionality of the entire server system 210.

The power source connectors 220a-b allow the midplane 212 to be electrically coupled to power supplies 222a-b. Although two power source connectors 220a-b are shown, other implementations may include only a single power source connector or more than two power source connectors.

The power supplies 222a-b are coupled to the midplane 212 via the power source connectors 220a-b. The power supplies 222a-b provide power generally to server elements of the server system 21. The power supplies 222a-b may include any device, system, or apparatus operable to supply power or electrical energy generally to one or more elements of the server system 21, including but not limited to, the midplane 212, the blade servers 214a-j, the management card 226 and the NIC 230. For example, one or o of power supplies 222a-b may include any system, device, and/or apparatus operable to supply direct current (DC) electrical power to one or more elements of server system 21. In some implementations, DC power sources may include a batter or an AC/DC adapter that may convert 120-volt, 240-volt, or any other suitable voltage alternating current supplied by a utility company to a regulated lower voltage DC power source. In addition, an AC/DC adapter may also charge a battery while supplying power to server system 210.

In addition, one or more of power supplies 222a-b may include any system, device, and/or apparatus operable to supply AC electrical power directly to one or more elements of server system 210. In some implementations, the delivered AC power may subsequently be converted into a DC power source (e.g., using an AC/DC converter). In some implementations, one or more power supplies 222a-b may include uninterruptible power sources or switch mode power sources internally or externally coupled to the server system 210. In some implementations, power supplies 222a-b may be assembled in a non-redundant configuration within the server system 210.

Each of the power supplies 222a-b may individually be referred to herein as “power supply 222.' In addition, any plurality of power supplies 222a-b may be collectively referred to herein as “power supplies 222.”

The management card connector 224 may serve as a port for a management card 226 to interface with the midplane 212. To this end, the management card connector 224 provides capability for the midplane 212 to manage its server resources and associate with the blade servers 214a-j in order to share a common network management card 226.

As previously mentioned the management card 226 may be coupled to the midplane 212 via the management card connector 224. The management card 226 may include its own processor operable to manage the resources of the server system 210. A management card 226 may provide chassis/blade monitoring and remote power control through a dedicated management network. Known server blade platforms provide the ability for remote chassis administration via a single management card that communicates to each of the blades in a chassis (e.g., via an Embedded Server Management card). Among many of the remote management capabilities that the ESM card provides is the ability to power down a server blade. Generally, an update directive will be issued via some type of management facility, such as via a management console in conjunction with the use of the management card 226, or via an external management server that is coupled to the blades 214 via an external network. Blade servers usually provide some type of management interface for managing operations of the individual blades. This may generally be facilitated by an out-of-band network or communication channel or channels. For example, one or more buses for facilitating a “private” or “management” network and appropriate switching may be built into the interface plane, or a private network may be implemented through closely-coupled network cabling and network. Optionally, the switching and other management functionality may be provided by a management card 226 that is coupled to the backside or front side of the interface plane. As yet another option, a management server may be employed to manage blade activities, wherein communications are handled via a standard computer networking infrastructure, such as Ethernet.

Continuing with FIG. 2, the server system 210 may further comprise a Network Interface Card (NIC) connector 228 which serves as a port operable to receive the NIC 230. The NIC 230 may be coupled to the midplane 212 through the NIC connector 228. The NIC connector 228 allows the midplane 212 to have network capabilities. The NIC 230 may be operable to provide the server system 210 with the ability to function and communicate with other IHSs in a network.

The midplane 212 may also include other replaceable network components such as connectors, resistors, and cooling systems to provide increased functionality to the midplane 212. The midplane 212 and all IHS components of the server system 210 may be housed in a single housing.

In one implementation, each of the blade servers 214a-j may function as an independent server independent of the other blade servers 214 In some implementations, the blade servers 214a-j may be thin, dense, modular electronic circuit boards containing one or more processors. The blade servers 214a-j may also include network functionality and storage capabilities such as memory. In addition to a processor and memory, the blade servers 214a-j may also include resistors, switches and integrated circuits, such as a complex programmable logic device.

The blade servers 214 a ⱼ may include the power connectors 218a-j. The power connectors 218a-j provide power from the blade connectors 216a-j on the midplane 212 to the blade servers 214a-j. In one implementation, power connectors 218a-j are integrated on each of the blade servers 214a-j.

To install the blade server(s) 214a-j within the server system 210, the user may insert a blade server 214a-j into the blade connectors 216a-j on the midplane 212. As shown, a user may install the server blade 214a into the blade connector 214a, the server blade 216b into the blade connector 216b, and the server blade 214j into the blade connector 216j. The server system 210 functions properly whether only one blade server 214a-j is installed, or all blade servers 214a-j are installed, or only a portion of the server blades 214a-j are installed and some of the blade connectors 216a-j are open.

The multi-blade server system 210 may utilize a high-speed communication bus to interconnect server elements such as the blade servers 214a-j, the blade connectors 216a-j, the midplane 212, the power supplies 222a-b, the management card 226, and the NIC 230, among other components. The communication bus may include any device, system or apparatus configured to transmit data and/or signals between the various elements of the server system 210. In one implementation, the blade servers 214a-j may maintain fast communication with each other,the power supplies 222a-b, the management card 226, and the NIC 230 via the midplane 212.

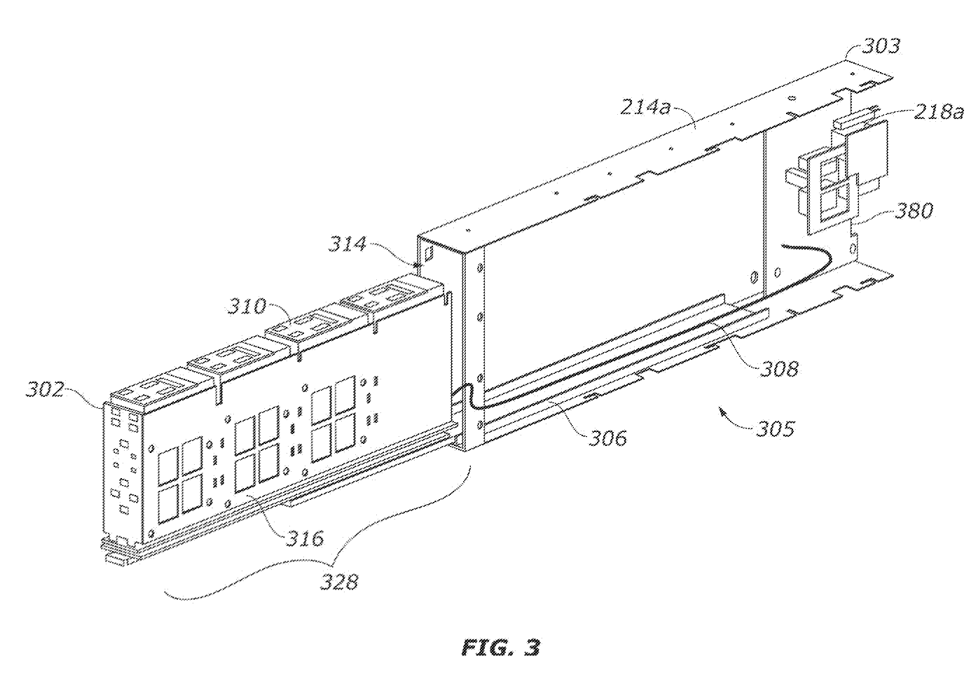

FIG. 3 illustrates an extended position of a blade server 214a-j in accordance with one aspect of the present disclosure. It is understood that an extended position may include a partially extended or fully extended position. In a fully extended position, an entire portion of the component housing 302 is not enclosed by a frame 303. While in a partially extended position, a portion of the component housing 302 may be enclosed by the frame 303. In one implementation, each of the blade servers 214a-j may a part of a rack assembly 305. The power source may be shared by the blade servers 214a-j through a power connector 218 a, which may be displaced in the rear portion 380 of the rack assembly 305.

The rack assembly 305 may include a frame 303. The rack assembly 305 may also include a component housing 302 for stacking IHS components 310 side by side along the length 328 of the component housing 302. The IHS components 310 disposed within the rack assembly 305 may be equipped with hot plug functions. The power connector 218 a may provide electric power to the IHS components 310 through each of the blade servers 214a-j. The component housing 302 and the frame 303 are structured such that the component housing 302 is operable to be displaced in and out of the frame 303, such as in an extended position or closed, i.e., locked position.

In one implementation, the component housing 302 comprises a slide assembly 306 attachable to the frame 303. Preferably, the component housing 302 is moveable in and out of an opening of the frame 303 movable along the slide assembly 306. Additionally, the side assembly 306 is operable to lock the component housing 302 in order to prevent movement of the component housing 302 relative to the frame 303 when the component housing 302 is fully extended by opening the frame 303.

Further, the component housing 302 has at least one extendable member 308, for example, a cable, extending from a rear portion of the frame 303 toward a rear portion 380 of the component housing 302. The extendable member 308 may allow the component housing 302 to be electrically coupled to the power source of the blade servers 214a-j. In one implementation, the extendable member 308 may allow the component housing 302 and the frame 303 to be electrically coupled when the component housing 302 is fully extended from an opening (e.g., front opening) of the frame 303.

In another implementation, the rear portion of the frame 303 includes a power connector 218a having mating connection sockets mounted thereon to be coupled with the extendable member 308. Likewise, the component housing 302 may include a printed circuit assembly (PCA), for example, a backplane 316 having mating connection sockets mounted thereon to be coupled with the extendable member 308 for establishing an electric power connection between the frame 303 and the component housing 302.

A backplane 316 may refer to a circuit board that connects (e.g., in parallel) several connectors to each other to form a computer bus. In server systems, a backplane 316 may be commonly used to attach hot pluggable hard drives. Pins on a backplane 316 may pass directly into hard drive sockets without cables. Further, a backplane 316 may offer a single connector to be connected with one disk array controller. Alternatively, a backplane 316 may have multiple connectors that can be connected to one or more controllers.

FIG. 3 also depicts the slide assembly 306 in a fully extended position. As depicted, when the slide assembly 306 is in a fully extended position, the component housing 302 provides top access and front access to IHS components 310 contained therein. It is understood by those skilled in the art that the top access to IHS components provides the users a direct entry for accessing the IHS components 310 from the top of the component housing 302. In one implementation, when additional hot pluggable IHS components 310 are needed to be added into each of the blade servers 214a-j, a user may simply extract the component housing 302 from the frame 303 and couple the IHS components 310 to the corresponding connectors disposed on the backplane 316 without taking any blade server 214a-j offline. Likewise, when IHS components 310 are damaged and need to be replaced, a user may access damaged IHS components 310 from the top of the component housing 302 rather than extracting the entire blade server 214a-j out of the chassis of the multi-blade server system 210 (shown in FIG. 2). In one implementation, the blade server 214a-j includes a slide assembly (not shown) r counted to the chassis of the r Multi-blade server system 210 for moving the blade server 214a-j in and out of an opening of the multi-blade server system 210.

The slide assembly 306 preferably can be fully retracted or closed to enable the component housing 302 attached thereto to be completely inserted into the rack system 303. The front portion of the component housing 302 normally provides an access to the IHS components 310 contained inside the component housing 302. In one implementation, a user may replace the damaged IHS components 310, for example, hot pluggable hard drive disks, from the front of the frame 303. However, some IHS components 310 may remain in the rear portion of the housing and may be inaccessible due to the long and narrow inner space of the blade server 214 a. If modification of the IHS components 310 requires adding or replacing any IHS components 310 that are inaccessible from the front portion of the component housing 302, a user may need to fully extend the component housing 302 from the rack system 303.

A hot pluggable blade sever 214a may be extended from the chassis of the multi-blade server system 210 for maintenance or repair purposes. A user may decide that only a single or few IHS components 310 need to be replaced or added for maintenance or repair. Given the present disclosure, the IHS components 310 can be replaced or added without power cycling or powering off the blade server 214a containing the damaged IHS components. Thus, the present disclosure of the rack assembly with the improved blade structure may be beneficial, especially for addressing the needs of a multi-blade server system 210 that can facilitate modification of hot pluggable IHS components 310 without powering off the entire multi-blade server system 210 or the entire blade server 214a-j. Additionally, the rack assembly and the improved multi-blade server system 210 may maximize the accessibility of the IHS components 210 inside the blade server 214a-j by providing top assess to the IHS components 210.

Although the present disclosure has been described with reference to particular examples, embodiments and/or implementations, those skilled in the art will recognize that modifications and variations may be made without departing from the spirit and scope of the claimed subject matter. Such changes in form and detail, including use of equivalent functional and/or structural substitutes for elements described herein, fall within the scope of the appended claims and are intended to be covered by this disclosure.

What is claimed is:

1. A rack assembly comprising:
a frame;
a housing for receiving a plurality of information handling system (IHS) components, the housing coupled to a slide assembly attached to the frame, wherein the frame is operable to receive the housing; and
an extendable member electrically coupling the housing to a power source disposed within the frame when the housing is in an extended position from the frame.

2. The rack assembly of claim 1, wherein the plurality of IHS components have hot plug functionality.

3. The rack assembly of claim 1, wherein the housing comprises a backplane comprising a printed circuit assembly (PCA) to electrically couple the power source of the frame to the plurality of IHS components.

4. The rack assembly of claim 1, wherein the housing is operable to provide top access to the plurality of IHS components.

5. The rack assembly of claim 1, wherein the power source of the frame is operable to provide electric power to the plurality of IHS components.

6. The rack assembly of claim 1, wherein the power source disposed within the frame is operable to provide electric power to the plurality of IHS components disposed within the housing when the housing is in an extended position from the frame.

7. The rack assembly of claim 1, wherein the slide assembly is operable to lock the housing in a fully extended position from a front opening of the frame.

8. An information handling system (IHS) comprising:
a chassis;
a blade server having a first slide assembly mounted within the chassis, wherein the first slide assembly is operable to receive the blade server;
a frame disposed within the blade server;
a housing for receiving a plurality of information handling system (IHS) components, the housing having a second slide assembly attachable to the frame, wherein the frame is operable to receive the housing; and
an extendable member electrically coupling the housing to a power source disposed within the frame when the housing is in an extended position from the frame.

9. The system of claim 8, wherein the plurality of IHS components have hot plug functionality.

10. The system of claim 8, wherein the housing comprises a backplane comprising a printed circuit assembly (PCA) to electrically couple the power source of the frame to the plurality of IHS components.

11. The system of claim 8, wherein the housing is operable to provide top access to the plurality of IHS components.

12. The system of claim 8, wherein the wherein the power source disposed within the frame is operable to provide electric power to the plurality of IHS components when the housing is in an extended position from the frame.

13. The system of claim 8, wherein the slide assembly is operable to lock the housing in a fully extended position from a front opening of the frame.

14. An information handling system (IHS) comprising:
a chassis;
a plurality of blade servers disposed within the chassis, wherein each of the plurality of blade servers comprises:
a first slide assembly mounted within the chassis for receiving each of the plurality of blade servers;
a frame mounted within each of the plurality of the blade servers;
a housing for receiving a plurality of information handling system (IHS) components, the housing having a second slide assembly attachable to the frame, wherein the frame is operable to receive the housing; and
an extendable member electrically coupling the housing to a power source disposed within the frame when the housing is in an extended position from the frame.

15. The system of claim 14, wherein the plurality of IHS components have hot plug functionality.

16. The system of claim 14, wherein the housing comprises a backplane comprising a printed circuit assembly (PCA) to electrically couple the power source of the frame to the plurality of IHS components.

17. The system of claim 14, wherein the housing is operable to provide top access to the plurality of IHS components.

18. The system of claim 14, wherein the wherein the power source disposed within the frame is operable to provide electric power to the plurality of IHS components when the housing is in an extended position from the frame.

19. The system of claim 14, wherein the slide assembly is operable to lock the housing in a fully extended position from a front opening of the frame.

20. The system of claim 14, wherein the plurality of IHS components are selected from a processor or memory.
